(19) United States
(12) Patent Application Publication
(10) Pub. No.: US 2026/0030613 A1
(43) Pub. Date: Jan. 29, 2026

(54) DIGITAL WALLET AUTHENTICATION SYSTEM AND METHOD

(71) Applicant: American Express Travel Related Services Company, Inc., New York, NY (US)

(72) Inventor: John Bruno, Scottsdale, AZ (US)

(21) Appl. No.: 18/781,347

(22) Filed: Jul. 23, 2024

Related U.S. Application Data
(62) Division of application No. 16/814,574, filed on Mar. 10, 2020, now abandoned.
Application No. 16/814,574 is a continuation of application No. 14/995,052, filed on Jan. 13, 2016, now abandoned.

(51) Int. Cl. G06Q 20/36; G06Q 20/40

(52) U.S. Cl. CPC G06Q 20/36; G06Q 20/4014

(57) ABSTRACT

The system may be configured to create and manage electronic credential information. The system may generate, by the computer based system and via a token engine, a first token. The system may associate, by the computer based system, the first token and the first electronic identification instrument. The system may further provision, by the computer based system and via a credential engine, a first electronic identification instrument and a first digital token associated with the first electronic identification instrument to a wallet application of a user device. The system may also provision, by the computer based system and via the credential engine, a second electronic identification instrument and a second digital token associated with the second electronic identification instrument to the wallet application of the user device.

### TECHNICAL FIELD

This disclosure generally relates to the management and administration of electronic credentials by digital wallets.

### BACKGROUND

A physical personal wallet typically contains items which belong to three categories, such as (1) currency (e.g., paper money, credit cards, debit cards, gift cards, discount cards, coupons, etc.), (2) identification (e.g., driver's license, insurance cards, health plan cards, passports, club membership cards, etc.), and (3) receipts (e.g., post transaction receipts like a cash register receipt for fuel, sales invoice for a furniture purchase, etc.). These items can create a bulky and unorganized wallet with items that are difficult to access or that may be lost. More recent digital wallets (like those offered on popular smartphones) allow users' to digitize portions of the wallet (e.g., wallets that allow for payments with credit, debit, and gift cards). However, there is still a need for a comprehensive solution that transforms more aspects of a physical wallet into a streamlined and organized digital wallet solution.

### SUMMARY

The systems, methods and computer program products (collectively “system”) may be configured to create and manage electronic credential information. The system may be configured to receive, by a computer based system and via an identity broker, first identity information from a first identity provider. The first identity information may include a first electronic identification instrument. The first electronic identification instrument may be government issued identification, insurance identification, loyalty program identification, or membership identification. The system may also generate, by the computer based system and via a token engine, a first token. The system may associate, by the computer based system, the first token and the first electronic identification instrument. The system may further provision, by the computer based system and via a credential engine, a first electronic identification instrument and a first digital token associated with the first electronic identification instrument to a wallet application of a user device. The system may receive, by the computer based system and via the identity broker, second identity information from a second identity provider. The system may also provision, by the computer based system and via the credential engine, a second electronic identification instrument and a second digital token associated with the second electronic identification instrument to the wallet application of the user device.

In various embodiments, the system may store, by the computer based system, the first token and the first electronic identification instrument in an identity database to create validation information. The system may further receive, by the computer based system and from an identify requester, the first token or the first electronic identification instrument. The system may also compare, by the computer based system, the first token and the first electronic identification instrument from the identity requestor with the validation information. The system may validate, by the computer based system and via the credential engine, the first token and the first electronic identification instrument based on the comparing.

In various embodiments, the identity requester may receive the first token or the first electronic identification instrument via a wallet reader. The wallet reader may be configured with any suitable communication method. For example, the wallet reader may be configured with a WIFI communication protocol, an RFID protocol, a cellular communication protocol, near field communication protocol and/or a Bluetooth communication protocol.

In various embodiments, the first token and the first electronic information is packaged with electronic transaction account information to complete a transaction. The transaction account information may be compared to the first electronic identification information or the first token. The first token or the first electronic information and the second token or the second electronic information may be packaged with electronic transaction account information to complete a transaction. The first token and the first electronic information may be associated with government issued identification. The second token and the second electronic information may be associated with insurance identification, loyalty program identification, or membership identification.

### BRIEF DESCRIPTION OF THE DRAWINGS

The features and advantages of the present disclosure will become more apparent from the detailed description set forth below when taken in conjunction with the drawings.

FIG. 1 is a system diagram showing an identity broker system, in accordance with various embodiments.

FIG. 2 is a partial system diagram of an identity broker system, in accordance with various embodiments.

FIG. 3 illustrates a first method for administering and creating an identity broker system, in accordance with various embodiments.

FIG. 4 illustrates a second method for administering and creating an identity broker system, in accordance with various embodiments.

### DETAILED DESCRIPTION

In various embodiments, the systems, methods and computer program products described herein are configured to create and manage electronic credentials. The detailed description of various embodiments makes reference to the accompanying drawings, which show various embodiments by way of illustration. While these various embodiments are described in sufficient detail to enable those skilled in the art to practice the disclosure, it should be understood that other embodiments may be realized and that logical and mechanical changes may be made without departing from the spirit and scope of the disclosure. Thus, the detailed description is presented for purposes of illustration only and not of limitation. For example, the steps recited in any of the method or process descriptions may be executed in any order and are not limited to the order presented. Moreover, any of the functions or steps may be outsourced to or performed by one or more third parties. Furthermore, any reference to singular includes plural embodiments, and any reference to more than one component may include a singular embodiment.

In various embodiments, the identity broker and wallet applications are configured to provide frictionless and/or secure access to all forms of identification documents on a mobile device. Users may securely store and retrieve certified electronic versions of their personal identification documents for use in online and offline transactions, where evidence of identity is required. By combining identification information and payment information together in a single wallet, financial transactions can be made more secure. In this regard, the wallet and identity broker system may reduce identity risk during payment transactions for users, transaction account issuers, merchants, payment processor, and/or the like. The wallet application and identity broker system may also be used with non-financial transactions.

The wallet application may be a micro-application, a mobile application, and/or web application which is directly accessible by a user on a user device. The user device may be configured to require appropriate credentials. Electronic identification documents may be encrypted and saved to a secure element on the user device or accessed online from the corresponding identity broker (e.g., a state department of transportation for drivers licenses) depending on the requirements of the identity broker. Wallet application access may be secured using biometric (e.g., fingerprint, retina, and/or the like) authentication or credential information (e.g., username and password, credential information supported by the FIDO (Fast Identity Online) protocol, and/or the like).

The user may register with an identity broker with a suitable website account and/or link their personal identification documents to the identity broker. The wallet application may coordinate with the identity broker on behalf of users to create accounts, link their personal identification documents to the identity broker, and/or provide secure access to the electronic identification documents. The identity broker may also be configured to automatically update user information based on user inputs or identity provider inputs. In this regard, the user may update an identity broker or an identity provider. The identity broker and identity provider may be configured to compare and match information. In this regard, the identity broker and identity provider may be configured to sync with one another.

In various embodiments, the identity broker may maintain the relationship between identity providers, merchants and users through the identity broker. Users may register with the identity broker. Registration may be accelerated by leveraging credentials from a trusted site (e.g., credential associated with a secure transaction account). In response to completing registration, the user may register with identity providers who are associated with and/or participating with the identity broker. While logged into the identity broker, the user may select one or more identity providers and provide enter personal information (e.g., full name, email, zip, phone, mother's maiden name, card number, social, photo, photocopy of existing documents, signed notary documents, and/or the like). The identity broker may forward the request to the identity provider for processing. Alternatively, the identify broker may act or be configured as pass a through to the actual identity provider portal or website. The user may also contact various identity providers individually. The identity broker may include “confidence” scoring based on registrations with other identity providers currently available for the user. For example, if the user already has a U.S. Passport registered in the same name, address, photo, then a user's health insurance card with corresponding personal information that sufficiently matches or correlates with the information associated with the registered item may be safer to approve. Transaction account credentials may also support a safer registration when considering some forms of identification. In some cases, an in-person visit may be required (e.g., to verify US Passport credentials, fingerprints, and/or the like). A 3rd party verification service may be used in some cases. At times the approval may be immediate depending on the supporting information provided by the identity broker. In this regard, the identity provider may inform the identity broker of approval and provide the necessary information to allow the identity broker to operate with the user's identification. Over time, the credibility of the user at the identity broker may improve as more identification documents are available.

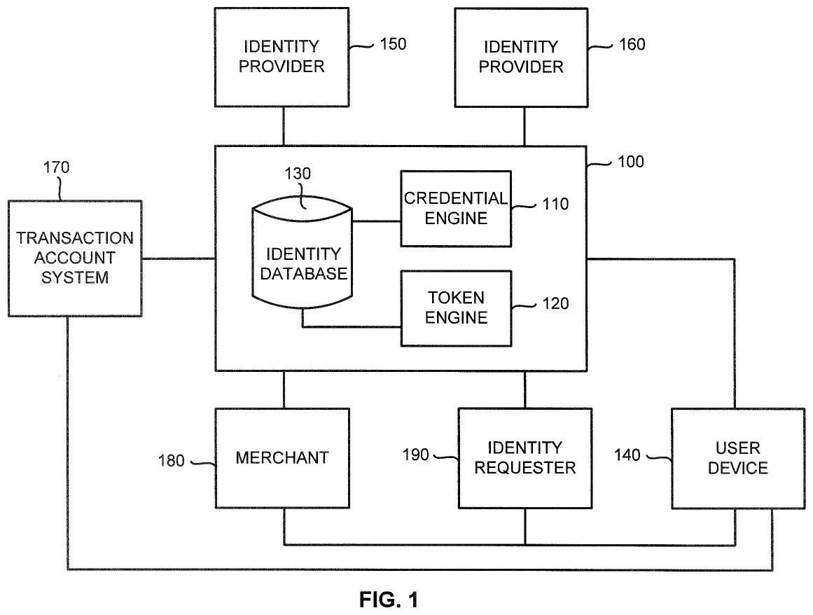

In various embodiments and with reference to FIG. 1, an identity broker 100 is provided. Identity broker 100 may be configured to create, manage, validate and otherwise maintain identity documents for a user. Identity broker 100 may comprise a credential engine 110, a token engine 120, an identity database 130, and/or the like.

Credential engine 110 may be configured to receive, request, manage, validate, and/or otherwise maintain or procure identity information from one or more identity providers (e.g., identity provider 150, identity provider 160, and/or the like). In this regard, credential engine 110 may be configured to sync or match information across disparate systems in various geographic locations, and various entities. For example, credential engine 110 may be configured to verify information from an identity provider in the United Kingdom for a party requesting identity information in the United States. Moreover, credential engine 110 may be configured to monitor the status of identity information. The status may be changed based on actions associated with a user and actions at an identity provider or an identity broker.

In various embodiments, token engine 120 may be configured to receive, create, manage, and/or otherwise maintain digital tokens created by identity broker 100 and/or one or more identity providers. Each of credential engine 110 and token engine 120 may be operatively coupled to and in electronic communication with identity database 130. Moreover, credential engine 110 and/or token engine 120 may be configured to access, store, and/or otherwise maintain identity information within identity database 130. Identity information may include, for example, electronic identification instruments and/or digital tokens.

In various embodiments, identity broker 100 may be in electronic communication with various other systems including, for example, a transaction account system 170, a merchant 180, an identity requester 190, and/or the like. Identity broker 100 may also be in communication with one or more identity providers such as, for example, identity provider 150, identity provider 160, and/or the like.

Transaction account system 170 may be any suitable transaction issuing, authorization, processing and/or settlement system. Moreover, transaction account system 170 may be configured to issue traditional and electronic payment accounts (e.g., debit transaction accounts, credit transaction accounts, charge accounts, prepaid accounts, and/or the like).

Merchant 180 may be a business or any person, entity, distributor system, software and/or hardware that is a provider, retailer, dealer, distributor, broker and/or any other entity in the distribution chain of goods or services. For example, a merchant may be a grocery store, a retail store, a travel agency, a service provider, an on-line merchant, and/or the like. Identity requester 190 may be merchant 180 or any other individual, entity, organization, governmental agency and/or the like that may request credential information, identification information and/or payment information from a user.

In various embodiments, identity broker 100 may be operatively coupled to and in electronic communication with a user device 140. User device 140 may be an Internet connected computing device, such as, for example, a tablet, a smartphone, a smart watch, wearable, and/or the like. In this regard, user device 140 may comprise a wallet application. The wallet application may be a portal or gateway between user device 140 and identity broker 100. The wallet application may be a micro application as described herein. Moreover, the wallet application may be downloaded and installed from an application marketplace on the user device.

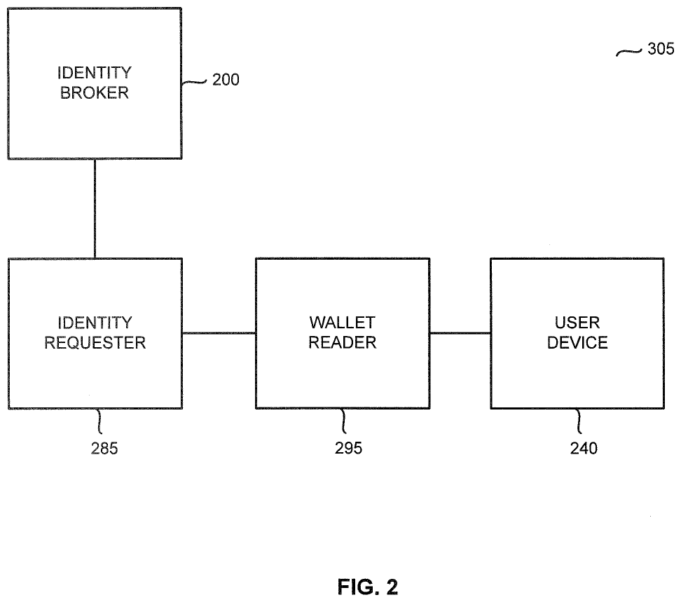

In various embodiments, and with reference to FIG. 2, identity broker 200 may be operatively coupled to and configured to receive identity information from identity requester 285. Identity requester 285 may be any suitable identity requester such as, for example, identity requester 190, merchant 180, a representative of a government, and/or any other suitable party. Identity requester 285 may have a wallet reader 295. Wallet reader 295 may be any suitable electronic device configured to communicate with user device 240. Wallet reader 295 may be configured with a wireless communication protocol such as, for example, an NFC communication protocol, a Bluetooth communication protocol, and/or any other suitable electronic communication protocol that is configured to exchange secure information between wallet reader 295 and user device 240.

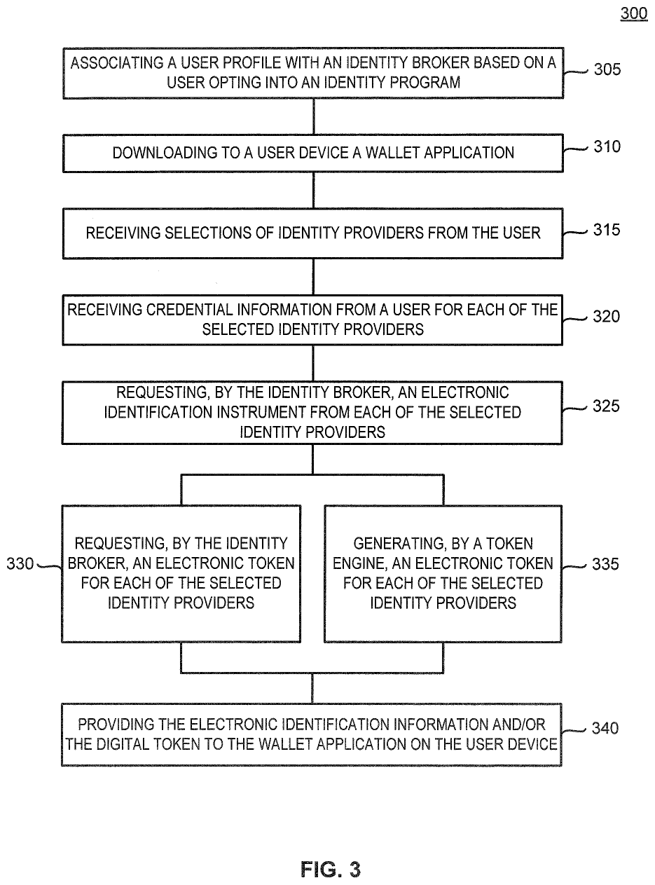

In various embodiments, and with reference to FIG. 1 and FIG. 3, the systems and devices described herein may be configured to perform a method 300 for using an identity broker. Method 300 may comprise associating a user profile with identity broker 100 based on a user opting in to an identity program (Step 305). The user may provide to identity broker 100 suitable identification information such as, for example, personally identifying information including a social security number, a driver's license number, address or residence information, information that may otherwise be collected as part of a credit card application or other suitable identity or membership application, and/or the like.

In various embodiments, method 300 may further comprise downloading to user device 140 a wallet application (Step 310). Method 300 may also comprise receiving selections of identity providers from the user (Step 315). The user may select one or more identity providers via a wallet application or a user interface provided by identity broker 100. Moreover, identity providers may include any suitable entity that issues a membership or identification card or account. For example, identity providers may include a motor vehicle department for a state or county or other governmental agency that issues driver's licenses and/or identification cards or identification accounts. Identity providers may also include loyalty program providers, insurance providers, merchants, and/or the like. Based on the selections of identity providers made by the user, identity broker 100 may collect or request validation information from the user for each identity provider.

In various embodiments, method 300 may further comprise receiving credential information from a user for each of the selected identity providers (Step 320). Method 300 may further comprise requesting by identity broker 100 an electronic instrument from each of the selected identity providers. As part the request from identity broker 100, credential engine 110 may bundle the credential information provided by the user for each of the selected identity providers. Moreover, credential engine 110 may send a request package that includes the credential information and a request for a particularly formatted electronic identification instrument. The electronic identification instrument may be any suitable electronic item. For example, an identity provider may issue an electronic identification instrument that has a likeness to the original document and is otherwise certified and/or embossed with a security feature and/or watermark. In this regard, the electronic identification instrument may be similar to and/or may have a likeness of an original document. For example, the electronic identification instrument for a driver's license may be a digital image of the driver's license that a motor vehicle department for a government agency may otherwise issue as a card. Moreover, both “sides” of the electronic identification instrument may be viewable along with the secure emblem (similar to the browser “lock”) signed by identity broker 100 to connote authenticity. The digital token may also be provided or presented to a reader to connote or verify authenticity.

In various embodiments, method 300 may further comprise requesting by identity broker 100 an electronic token from each of the selected identity providers. Alternatively, method 300 may comprise generating, by token engine 120, an electronic token for each of the selected identity providers. In this regard, a digital token may be associated with each electronic identification instrument as a way of further validating the authenticity of the electronic identification instrument. Method 300 may further comprise providing the electronic identification information and/or the digital tokens to the wallet application on user device 140 for each of the selected identity providers.

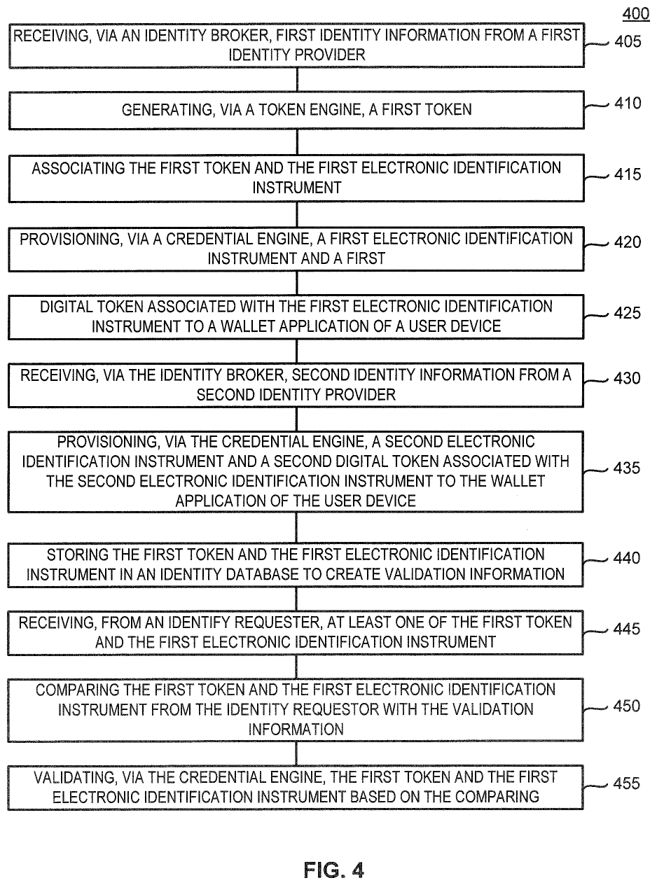

In various embodiments, and with reference to FIG. 1 and FIG. 4, the systems modules and engines described herein may be configured to perform a method 400 for administering identity broker 100. Method 400 may comprise receiving via identity broker 100 first identity information from a first identity provider 150 (Step 405). The first identity information may include a first electronic identification instrument. The first electronic identification instrument may be at least one of a government issued identification, insurance identification, loyalty program identification, and/or membership identification. Method 400 may further comprise generating via token engine 120 a first token (Step 410). Method 400 may further comprise associating the first token with the first electronic identification instrument (Step 415). In this regard, the first token and the first electronic identification instrument may be coupled together and presented together to the wallet reader of an identity requester. In this regard, the first electronic identification instrument and the first token may be evaluated together to confirm that the first electronic identification instrument is authentic. Method 400 may further comprise provisioning via credential engine 110 a second electronic identification instrument and a second digital token associated with the second electronic identification instrument to the wallet application of user device 140. In this regard, identity broker 100 may be configured to provision a plurality of electronic identification instruments and associated digital tokens to the wallet. Stated another way, identity broker 100 may be configured to provision an electronic identification instrument and corresponding token for any suitable transaction and/or identification instrument. In this regard, identity broker 100 may be configured to provision an electronic transaction instrument and/or electronic identification instruments from transaction account system 170 and one or more identity providers respectively.

In various embodiments, method 400 may further comprise storing the first token and the first electronic identification instrument in identity database 130 to create validation information. Validation information may be a summary or other information that is representative of the first electronic identification instrument or the first token. Method 400 may further comprise receiving from an identity requester at least one of the first token or the first electronic identification instrument. The first token and/or first electronic identification instrument received from the identity requester may be bundled with or packaged with a request to validate, verify, authorize, and/or otherwise confirm that the electronic instrument or token being provided is authentic and/or corresponds to a particular user account. As such, method 400 may further comprise comparing at least one of the first token or the first electronic identification instrument from the identity requester to the validation information. In this regard, the first token or first electronic identification instrument may be analyzed based on the validation information stored within identity database 130 to confirm the authenticity of the first token and/or first electronic identification instrument. In response to the validation information being sufficiently similar to the first token or the first electronic identification instrument, method 400 may further comprise validating via credential engine 110 the first token and/or the first electronic identification instrument.

In various embodiments, identification documents or a digital token may be simultaneously transmitted electronically to a merchant as part of a payment transaction (e.g., in an on-line or off-line transaction). In this regard, identification documents that support a purchase transaction may be bundled together and provided with electronic payment information. For example, a user may elect to have certified details of his driver's license and insurance identification transmitted electronically along with payment information when renting a car from a rental agency either in person or as part of an online transaction. Merchants may also use a QR-code (e.g., a one time use code shown in mobile wallet on rendered id) with their reader in order to access the identity information.

In various embodiments, identity broker 100 may facilitate non-payment transactions as well. For example, a user may provide her driver's license, insurance card, and registration to a police officer during a traffic incident, or a health insurance card to an administrator at a doctor's office, and a customer loyalty card to a merchant. Electronic transmission of these electronic identification documents or associated digital tokens may also be performed in those scenarios as well. For example, a computer terminal or other suitable electronic device operated by the police officer, administrator or merchant.

Systems, methods and computer program products are provided. In the detailed description herein, references to “various embodiments”, “one embodiment”, “an embodiment”, “an example embodiment”, etc., indicate that the embodiment described may include a particular feature, structure, or characteristic, but every embodiment may not necessarily include the particular feature, structure, or characteristic. Moreover, such phrases are not necessarily referring to the same embodiment. Further, when a particular feature, structure, or characteristic is described in connection with an embodiment, it is submitted that it is within the knowledge of one skilled in the art to affect such feature, structure, or characteristic in connection with other embodiments whether or not explicitly described. After reading the description, it will be apparent to one skilled in the relevant art(s) how to implement the disclosure in alternative embodiments.

Phrases and terms similar to an “item” may include any good, service, merchant, information, experience, data, content, access, rental, lease, contribution, account, credit, debit, benefit, right, reward, points, coupons, credits, monetary equivalent, anything of value, something of minimal or no value, monetary value, non-monetary value and/or the like.

The phrases consumer, customer, user, account holder, account affiliate, cardmember and/or the like shall include any person, entity, business, government organization, business, software, hardware, machine associated with a transaction account, buys merchant offerings offered by one or more merchants using the account and/or is designated for performing transactions on the account, regardless of whether a physical card is associated with the account. For example, the cardmember may include a transaction account owner, a transaction account user, an account affiliate, a child account user, a subsidiary account user, a beneficiary of an account, a custodian of an account, and/or any other person or entity affiliated or associated with a transaction account.

Terms and phrases similar to “sync,” “syncing,” and/or “synchronizing” may include associating, tagging, flagging, correlating, using a look-up table or any other method or system for indicating or creating a relationship between elements such as, for example (i) a transaction account and (ii) an item (e.g., offer, reward, discount) and/or digital channel. Moreover, the sync may occur at any point, in response to any suitable action, event, or period of time. The sync may occur at pre-determined intervals, periodic, randomly, once, more than once, or in response to a suitable request or action.

Terms and phrases similar to “associate” and/or “associating” may include tagging, flagging, correlating, using a look-up table or any other method or system for indicating or creating a relationship between elements, such as, for example, (i) a transaction account and (ii) an item (e.g., offer, reward, discount) and/or digital channel. Moreover, the associating may occur at any point, in response to any suitable action, event, or period of time. The associating may occur at pre-determined intervals, periodic, randomly, once, more than once, or in response to a suitable request or action.

Any communication, transmission and/or channel discussed herein may include any system or method for delivering content (e.g. data, information, metadata, etc.), and/or the content itself. The ID may be available within a mobile app. The D may also be part of an instant message and transmitted to a variety of devices including mobile phones and other devices. The content may be presented in any form or medium, and in various embodiments, the content may be delivered electronically and/or capable of being presented electronically. For example, a channel may comprise a website, a uniform resource locator (“URL”), a document (e.g., a Microsoft Word document, a Microsoft Excel document, an Adobe.pdf document, etc.), an “ebook,” an “emagazine,” an application or microapplication (as described below), an SMS or other type of text message, an email, Facebook, Twitter, MMS and/or other type of communication technology. In various embodiments, a channel may be hosted or provided by a data partner. In various embodiments, the distribution channel may comprise at least one of a merchant website, a social media website, affiliate or partner websites, an external vendor, a mobile device communication, social media network and/or location based service. Distribution channels may include at least one of a merchant website, a social media site, affiliate or partner websites, an external vendor, or a mobile device communication. Examples of social media sites include Facebook®, Foursquare®, Twitters®, MySpace®, LinkedIn®, and the like. Examples of affiliate or partner websites include American Express®, Groupon®, LivingSocial®, and the like. Moreover, examples of mobile device communications include texting, email, and mobile applications for smartphones.

A “consumer profile” or “consumer profile data” may comprise any information or data about a consumer that describes an attribute associated with the consumer (e.g., a preference, an interest, demographic information, personally identifying information, and the like).

In various embodiments, the methods described herein are implemented using the various particular machines described herein. The methods described herein may be implemented using the below particular machines, and those hereinafter developed, in any suitable combination, as would be appreciated immediately by one skilled in the art. Further, as is unambiguous from this disclosure, the methods described herein may result in various transformations of certain articles.

For the sake of brevity, conventional data networking, application development and other functional aspects of the systems (and components of the individual operating components of the systems) may not be described in detail herein. Furthermore, the connecting lines shown in the various figures contained herein are intended to represent exemplary functional relationships and/or physical couplings between the various elements. It should be noted that many alternative or additional functional relationships or physical connections may be present in a practical system.

The various system components discussed herein may include one or more of the following: a host server or other computing systems including a processor for processing digital data; a memory coupled to the processor for storing digital data; an input digitizer coupled to the processor for inputting digital data; an application program stored in the memory and accessible by the processor for directing processing of digital data by the processor; a display device coupled to the processor and memory for displaying information derived from digital data processed by the processor; and a plurality of databases. Various databases used herein may include: client data; merchant data; financial institution data; and/or like data useful in the operation of the system. As those skilled in the art will appreciate, user computer may include an operating system (e.g., Windows OS, UNIX, Linux, Solaris, MacOS, etc.) as well as various conventional support software and drivers typically associated with computers.

The present system or any part(s) or function(s) thereof may be implemented using hardware, software or a combination thereof and may be implemented in one or more computer systems or other processing systems. However, the manipulations performed by embodiments were often referred to in terms, such as matching or selecting, which are commonly associated with mental operations performed by a human operator. No such capability of a human operator is necessary, or desirable in most cases, in any of the operations described herein. Rather, the operations may be machine operations. Useful machines for performing the various embodiments include general purpose digital computers or similar devices.

In fact, in various embodiments, the embodiments are directed toward one or more computer systems capable of carrying out the functionality described herein. The computer system includes one or more processors, such as processor. The processor is connected to a communication infrastructure (e.g., a communications bus, cross over bar, or network). Various software embodiments are described in terms of this exemplary computer system. After reading this description, it will become apparent to a person skilled in the relevant art(s) how to implement various embodiments using other computer systems and/or architectures. Computer system can include a display interface that forwards graphics, text, and other data from the communication infrastructure (or from a frame buffer not shown) for display on a display unit.

Computer system also includes a main memory, such as for example random access memory (RAM), and may also include a secondary memory. The secondary memory may include, for example, a hard disk drive and/or a removable storage drive, representing a floppy disk drive, a magnetic tape drive, an optical disk drive, etc. The removable storage drive reads from and/or writes to a removable storage unit in a well-known manner. Removable storage unit represents a floppy disk, magnetic tape, optical disk, etc. which is read by and written to by removable storage drive. As will be appreciated, the removable storage unit includes a computer usable storage medium having stored therein computer software and/or data.

In various embodiments, secondary memory may include other similar devices for allowing computer programs or other instructions to be loaded into computer system. Such devices may include, for example, a removable storage unit and an interface. Examples of such may include a program cartridge and cartridge interface (such as that found in video game devices), a removable memory chip (such as an erasable programmable read only memory (EPROM), or programmable read only memory (PROM)) and associated socket, and other removable storage units and interfaces, which allow software and data to be transferred from the removable storage unit to computer system.

Computer system may also include a communications interface. Communications interface allows software and data to be transferred between computer system and external devices. Examples of communications interface may include a modem, a network interface (such as an Ethernet card), a communications port, a Personal Computer Memory Card International Association (PCMCIA) slot and card, etc. Software and data transferred via communications interface are in the form of signals which may be electronic, electromagnetic, and optical or other signals capable of being received by communications interface. These signals are provided to communications interface via a communications path (e.g., channel). This channel carries signals and may be implemented using wire, cable, fiber optics, a telephone line, a cellular link, a radio frequency (RF) link, wireless and other communications channels.

The terms “computer program medium” and “computer usable medium” are used to generally refer to media such as removable storage drive and a hard disk installed in hard disk drive. These computer program products provide software to computer system.

Computer programs (also referred to as computer control logic) are stored in main memory and/or secondary memory. Computer programs may also be received via communications interface. Such computer programs, when executed, enable the computer system to perform the features as discussed herein. In particular, the computer programs, when executed, enable the processor to perform the features of various embodiments. Accordingly, such computer programs represent controllers of the computer system.

In various embodiments, software may be stored in a computer program product and loaded into computer system using removable storage drive, hard disk drive or communications interface. The control logic (software), when executed by the processor, causes the processor to perform the functions of various embodiments as described herein. In various embodiments, hardware components such as application specific integrated circuits (ASICs). Implementation of the hardware state machine so as to perform the functions described herein will be apparent to persons skilled in the relevant art(s).

In various embodiments, the server may include application servers (e.g. WEB SPHERE, WEB LOGIC, JBOSS). In various embodiments, the server may include web servers (e.g. APACHE, IIS, GWS, SUN JAVA SYSTEM WEB SERVER).

A web client includes any device (e.g., personal computer) which communicates via any network, for example such as those discussed herein. Such browser applications comprise Internet browsing software installed within a computing unit or a system to conduct online transactions and/or communications. These computing units or systems may take the form of a computer or set of computers, although other types of computing units or systems may be used, including laptops, notebooks, tablets, hand held computers, personal digital assistants, set-top boxes, workstations, computer-servers, main frame computers, mini-computers, PC servers, pervasive computers, network sets of computers, personal computers, such as iPhones, iPads, iMacs, and MacBooks, kiosks, terminals, point of sale (POS) devices and/or terminals, televisions, or any other device capable of receiving data over a network. A web-client may run Microsoft Internet Explorer, Mozilla Firefox, Google Chrome, Apple Safari, or any other of the myriad software packages available for browsing the internet.

Practitioners will appreciate that a web client may or may not be in direct contact with an application server. For example, a web client may access the services of an application server through another server and/or hardware component, which may have a direct or indirect connection to an Internet server. For example, a web client may communicate with an application server via a load balancer. In an exemplary embodiment, access is through a network or the Internet through a commercially-available web-browser software package.

As those skilled in the art will appreciate, a web client includes an operating system (e.g., Windows OS, UNIX, Linux, Solaris, MacOS, etc.) as well as various conventional support software and drivers typically associated with computers. A web client may include any suitable personal computer, network computer, workstation, personal digital assistant, cellular phone, smart phone, minicomputer, mainframe or the like. A web client can be in a home or business environment with access to a network. In an exemplary embodiment, access is through a network or the Internet through a commercially available web-browser software package. A web client may implement security protocols such as Secure Sockets Layer (SSL) and Transport Layer Security (TLS). A web client may implement several application layer protocols including http, https, ftp, and sftp.

In various embodiments, components, modules, and/or engines of identity broker 200 may be implemented as micro-applications or micro-apps. Micro-apps are typically deployed in the context of a mobile operating system, including for example, a Windows mobile operating system, an Android Operating System, Apple IOS, a Blackberry operating system and the like. The micro-app may be configured to leverage the resources of the larger operating system and associated hardware via a set of predetermined rules which govern the operations of various operating systems and hardware resources. For example, where a micro-app desires to communicate with a device or network other than the mobile device or mobile operating system, the micro-app may leverage the communication protocol of the operating system and associated device hardware under the predetermined rules of the mobile operating system. Moreover, where the micro-app desires an input from a user, the micro-app may be configured to request a response from the operating system which monitors various hardware components and communicates a detected input from the hardware to the micro-app.

As used herein, the term “network” includes any cloud, cloud computing system or electronic communications system or method which incorporates hardware and/or software components. Communication among the parties may be accomplished through any suitable communication channels, such as, for example, a telephone network, an extranet, an intranet, Internet, point of interaction device (point of sale device, personal digital assistant (e.g., iPhone®, Blackberry®), cellular phone, kiosk, etc.), online communications, satellite communications, off-line communications, wireless communications, transponder communications, local area network (LAN), wide area network (WAN), virtual private network (VPN), networked or linked devices, keyboard, mouse and/or any suitable communication or data input modality. Moreover, although the system is frequently described herein as being implemented with TCP/IP communications protocols, the system may also be implemented using IPX, Appletalk, IP-6, NetBIOS, OSI, any tunneling protocol (e.g. IPsec, SSH), or any number of existing or future protocols. If the network is in the nature of a public network, such as the Internet, it may be advantageous to presume the network to be insecure and open to eavesdroppers. Specific information related to the protocols, standards, and application software utilized in connection with the Internet is generally known to those skilled in the art and, as such, need not be detailed herein.

The various system components may be independently, separately or collectively suitably coupled to the network via data links which includes, for example, a connection to an Internet Service Provider (ISP) over the local loop as is typically used in connection with standard modern communication, cable modem, Dish networks, ISDN, Digital Subscriber Line (DSL), or various wireless communication methods. It is noted that the network may be implemented as other types of networks, such as an interactive television (ITV) network. Moreover, the system contemplates the use, sale or distribution of any goods, services or information over any network having similar functionality described herein.

“Cloud” or “Cloud computing” includes a model for enabling convenient, on-demand network access to a shared pool of configurable computing resources (e.g., networks, servers, storage, applications, and services) that can be rapidly provisioned and released with minimal management effort or service provider interaction. Cloud computing may include location-independent computing, whereby shared servers provide resources, software, and data to computers and other devices on demand. For more information regarding cloud computing, see the NIST's (National Institute of Standards and Technology) definition of cloud computing.

As used herein, “transmit” may include sending electronic data from one system component to another over a network connection. Additionally, as used herein, “data” may include encompassing information such as commands, queries, files, data for storage, and the like in digital or any other form.

As used herein, “issue a debit”, “debit” or “debiting” refers to either causing the debiting of a stored value or prepaid card-type financial account, or causing the charging of a credit or charge card-type financial account, as applicable.

The system contemplates uses in association with web services, utility computing, pervasive and individualized computing, security and identity solutions, autonomic computing, cloud computing, commodity computing, mobility and wireless solutions, open source, biometrics, grid computing and/or mesh computing.

Any databases discussed herein may include relational, hierarchical, graphical, or object-oriented structure and/or any other database configurations. Common database products that may be used to implement the databases include DB2 by IBM (Armonk, N.Y.), various database products available from Oracle Corporation (Redwood Shores, Calif.), Microsoft Access or Microsoft SQL Server by Microsoft Corporation (Redmond, Wash.), MySQL by MySQL AB (Uppsala, Sweden), or any other suitable database product. Moreover, the databases may be organized in any suitable manner, for example, as data tables or lookup tables. Each record may be a single file, a series of files, a linked series of data fields or any other data structure. Association of certain data may be accomplished through any desired data association technique such as those known or practiced in the art. For example, the association may be accomplished either manually or automatically. Automatic association techniques may include, for example, a database search, a database merge, GREP, AGREP, SQL, using a key field in the tables to speed searches, sequential searches through all the tables and files, sorting records in the file according to a known order to simplify lookup, and/or the like. The association step may be accomplished by a database merge function, for example, using a “key field” in pre-selected databases or data sectors. Various database tuning steps are contemplated to optimize database performance. For example, frequently used files such as indexes may be placed on separate file systems to reduce In/Out (“I/O”) bottlenecks.

More particularly, a “key field” partitions the database according to the high-level class of objects defined by the key field. For example, certain types of data may be designated as a key field in a plurality of related data tables and the data tables may be linked on the basis of the type of data in the key field. The data corresponding to the key field in each of the linked data tables is preferably the same or of the same type. However, data tables having similar, though not identical, data in the key fields may also be linked by using AGREP, for example. In accordance with one embodiment, any suitable data storage technique may be utilized to store data without a standard format. Data sets may be stored using any suitable technique, including, for example, storing individual files using an ISO/IEC 7816-4 file structure; implementing a domain whereby a dedicated file is selected that exposes one or more elementary files containing one or more data sets; using data sets stored in individual files using a hierarchical filing system; data sets stored as records in a single file (including compression, SQL accessible, hashed via one or more keys, numeric, alphabetical by first tuple, etc.); Binary Large Object (BLOB); stored as ungrouped data elements encoded using ISO/IEC 7816-6 data elements; stored as ungrouped data elements encoded using ISO/IEC Abstract Syntax Notation (ASN.1) as in ISO/IEC 8824 and 8825; and/or other proprietary techniques that may include fractal compression methods, image compression methods, etc.

In one exemplary embodiment, the ability to store a wide variety of information in different formats is facilitated by storing the information as a BLOB. Thus, any binary information can be stored in a storage space associated with a data set. As discussed above, the binary information may be stored on the financial transaction instrument or external to but affiliated with the financial transaction instrument. The BLOB method may store data sets as ungrouped data elements formatted as a block of binary via a fixed memory offset using either fixed storage allocation, circular queue techniques, or best practices with respect to memory management (e.g., paged memory, least recently used, etc.). By using BLOB methods, the ability to store various data sets that have different formats facilitates the storage of data associated with the financial transaction instrument by multiple and unrelated owners of the data sets. For example, a first data set which may be stored may be provided by a first party, a second data set which may be stored may be provided by an unrelated second party, and yet a third data set which may be stored, may be provided by an third party unrelated to the first and second party. Each of these three exemplary data sets may contain different information that is stored using different data storage formats and/or techniques. Further, each data set may contain subsets of data that also may be distinct from other subsets.

As stated above, in various embodiments, the data can be stored without regard to a common format. However, in one exemplary embodiment, the data set (e.g., BLOB) may be annotated in a standard manner when provided for manipulating the data onto the financial transaction instrument. The annotation may comprise a short header, trailer, or other appropriate indicator related to each data set that is configured to convey information useful in managing the various data sets. For example, the annotation may be called a “condition header”, “header”, “trailer”, or “status”, herein, and may comprise an indication of the status of the data set or may include an identifier correlated to a specific issuer or owner of the data. In one example, the first three bytes of each data set BLOB may be configured or configurable to indicate the status of that particular data set; e.g., LOADED, INITIALIZED, READY, BLOCKED, REMOVABLE, or DELETED. Subsequent bytes of data may be used to indicate for example, the identity of the issuer, user, transaction/membership account identifier or the like. Each of these condition annotations are further discussed herein.

The data set annotation may also be used for other types of status information as well as various other purposes. For example, the data set annotation may include security information establishing access levels. The access levels may, for example, be configured to permit only certain individuals, levels of employees, companies, or other entities to access data sets, or to permit access to specific data sets based on the transaction, merchant, issuer, user or the like. Furthermore, the security information may restrict/permit only certain actions such as accessing, modifying, and/or deleting data sets. In one example, the data set annotation indicates that only the data set owner or the user are permitted to delete a data set, various identified users may be permitted to access the data set for reading, and others are altogether excluded from accessing the data set. However, other access restriction parameters may also be used allowing various entities to access a data set with various permission levels as appropriate.

The data, including the header or trailer may be received by a standalone interaction device configured to add, delete, modify, or augment the data in accordance with the header or trailer. As such, in one embodiment, the header or trailer is not stored on the transaction device along with the associated issuer-owned data but instead the appropriate action may be taken by providing to the transaction instrument user at the stand alone device, the appropriate option for the action to be taken. The system may contemplate a data storage arrangement wherein the header or trailer, or header or trailer history, of the data is stored on the transaction instrument in relation to the appropriate data.

One skilled in the art will also appreciate that, for security reasons, any databases, systems, devices, servers or other components of the system may consist of any combination thereof at a single location or at multiple locations, wherein each database or system includes any of various suitable security features, such as firewalls, access codes, encryption, decryption, compression, decompression, and/or the like.

Encryption may be performed by way of any of the techniques now available in the art or which may become available—e.g., Twofish, RSA, El Gamal, Schorr signature, DSA, PGP, PKI, GPG (GnuPG), and symmetric and asymmetric cryptosystems.

The computing unit of the web client may be further equipped with an Internet browser connected to the Internet or an intranet using standard dial-up, cable, DSL or any other Internet protocol known in the art. Transactions originating at a web client may pass through a firewall in order to prevent unauthorized access from users of other networks. Further, additional firewalls may be deployed between the varying components of CMS to further enhance security.

Firewall may include any hardware and/or software suitably configured to protect CMS components and/or enterprise computing resources from users of other networks. Further, a firewall may be configured to limit or restrict access to various systems and components behind the firewall for web clients connecting through a web server. Firewall may reside in varying configurations including Stateful Inspection, Proxy based, access control lists, and Packet Filtering among others. Firewall may be integrated within a web server or any other CMS components or may further reside as a separate entity. A firewall may implement network address translation (“NAT”) and/or network address port translation (“NAPT”). A firewall may accommodate various tunneling protocols to facilitate secure communications, such as those used in virtual private networking. A firewall may implement a demilitarized zone (“DMZ”) to facilitate communications with a public network such as the Internet. A firewall may be integrated as software within an Internet server, any other application server components or may reside within another computing device or may take the form of a standalone hardware component.

The computers discussed herein may provide a suitable website or other Internet-based graphical user interface which is accessible by users. In one embodiment, the Microsoft Internet Information Server (IIS), Microsoft Transaction Server (MTS), and Microsoft SQL Server, are used in conjunction with the Microsoft operating system, Microsoft NT web server software, a Microsoft SQL Server database system, and a Microsoft Commerce Server. Additionally, components such as Access or Microsoft SQL Server, Oracle, Sybase, Informix MySQL, Interbase, etc., may be used to provide an Active Data Object (ADO) compliant database management system. In one embodiment, the Apache web server is used in conjunction with a Linux operating system, a MySQL database, and the Perl, PHP, and/or Python programming languages.

Any of the communications, inputs, storage, databases or displays discussed herein may be facilitated through a website having web pages. The term “web page” as it is used herein is not meant to limit the type of documents and applications that might be used to interact with the user. For example, a typical website might include, in addition to standard HTML documents, various forms, Java applets, JavaScript, active server pages (ASP), common gateway interface scripts (CGI), extensible markup language (XML), dynamic HTML, cascading style sheets (CSS), AJAX (Asynchronous Javascript And XML), helper applications, plug-ins, and the like. A server may include a web service that receives a request from a web server, the request including a URL (http://yahoo.com/stockquotes/ge) and an IP address (123.56.789.234). The web server retrieves the appropriate web pages and sends the data or applications for the web pages to the IP address. Web services are applications that are capable of interacting with other applications over a communications means, such as the Internet. Web services are typically based on standards or protocols such as XML, SOAP, AJAX, WSDL and UDDI. Web services methods are well known in the art, and are covered in many standard texts.

Middleware may include any hardware and/or software suitably configured to facilitate communications and/or process transactions between disparate computing systems. Middleware components are commercially available and known in the art. Middleware may be implemented through commercially available hardware and/or software, through custom hardware and/or software components, or through a combination thereof. Middleware may reside in a variety of configurations and may exist as a standalone system or may be a software component residing on the Internet server. Middleware may be configured to process transactions between the various components of an application server and any number of internal or external systems for any of the purposes disclosed herein. WebSphere MQ™ (formerly MQSeries) by IBM, Inc. (Armonk, N.Y.) is an example of a commercially available middleware product. An Enterprise Service Bus (“ESB”) application is another example of middleware.

Practitioners will also appreciate that there are a number of methods for displaying data within a browser-based document. Data may be represented as standard text or within a fixed list, scrollable list, drop-down list, editable text field, fixed text field, pop-up window, and the like. Likewise, there are a number of methods available for modifying data in a web page such as, for example, free text entry using a keyboard, selection of menu items, check boxes, option boxes, and the like.

The system and method may be described herein in terms of functional block components, screen shots, optional selections and various processing steps. It should be appreciated that such functional blocks may be realized by any number of hardware and/or software components configured to perform the specified functions. For example, the system may employ various integrated circuit components, e.g., memory elements, processing elements, logic elements, look-up tables, and the like, which may carry out a variety of functions under the control of one or more microprocessors or other control devices. Similarly, the software elements of the system may be implemented with any programming or scripting language such as C, C++, C#, Java, JavaScript, VBScript, Macromedia Cold Fusion, COBOL, Microsoft Active Server Pages, assembly, PERL, PHP, awk, Python, Visual Basic, SQL Stored Procedures, PL/SQL, any UNIX shell script, and extensible markup language (XML) with the various algorithms being implemented with any combination of data structures, objects, processes, routines or other programming elements. Further, it should be noted that the system may employ any number of conventional techniques for data transmission, signaling, data processing, network control, and the like. Still further, the system could be used to detect or prevent security issues with a client-side scripting language, such as JavaScript, VBScript or the like.

The merchant computer and the bank computer may be interconnected via a second network, referred to as a payment network. The payment network which may be part of certain transactions represents existing proprietary networks that presently accommodate transactions for credit cards, debit cards, and other types of financial/banking cards. The payment network is a closed network that is assumed to be secure from eavesdroppers. Exemplary transaction networks may include the American Express®, VisaNet® and the Veriphone® networks.

The electronic commerce system may be implemented at the customer and issuing bank. In an exemplary implementation, the electronic commerce system is implemented as computer software modules loaded onto the customer computer and the banking computing center. The merchant computer does not require any additional software to participate in the online commerce transactions supported by the online commerce system.

As will be appreciated by one of ordinary skill in the art, the system may be embodied as a customization of an existing system, an add-on product, a processing apparatus executing upgraded software, a stand-alone system, a distributed system, a method, a data processing system, a device for data processing, and/or a computer program product. Accordingly, any portion of the system or a module may take the form of a processing apparatus executing code, an internet based embodiment, an entirely hardware embodiment, or an embodiment combining aspects of the internet, software and hardware. Furthermore, the system may take the form of a computer program product on a computer-readable storage medium having computer-readable program code means embodied in the storage medium. Any suitable computer-readable storage medium may be utilized, including hard disks, CD-ROM, optical storage devices, magnetic storage devices, and/or the like.

The system and method is described herein with reference to screen shots, block diagrams and flowchart illustrations of methods, apparatus (e.g., systems), and computer program products according to various embodiments. It will be understood that each functional block of the block diagrams and the flowchart illustrations, and combinations of functional blocks in the block diagrams and flowchart illustrations, respectively, can be implemented by computer program instructions.

These computer program instructions may be loaded onto a general purpose computer, special purpose computer, or other programmable data processing apparatus to produce a machine, such that the instructions that execute on the computer or other programmable data processing apparatus create means for implementing the functions specified in the flowchart block or blocks. These computer program instructions may also be stored in a computer-readable memory that can direct a computer or other programmable data processing apparatus to function in a particular manner, such that the instructions stored in the computer-readable memory produce an article of manufacture including instruction means which implement the function specified in the flowchart block or blocks. The computer program instructions may also be loaded onto a computer or other programmable data processing apparatus to cause a series of operational steps to be performed on the computer or other programmable apparatus to produce a computer-implemented process such that the instructions which execute on the computer or other programmable apparatus provide steps for implementing the functions specified in the flowchart block or blocks.

Accordingly, functional blocks of the block diagrams and flowchart illustrations support combinations of means for performing the specified functions, combinations of steps for performing the specified functions, and program instruction means for performing the specified functions. It will also be understood that each functional block of the block diagrams and flowchart illustrations, and combinations of functional blocks in the block diagrams and flowchart illustrations, can be implemented by either special purpose hardware-based computer systems which perform the specified functions or steps, or suitable combinations of special purpose hardware and computer instructions. Further, illustrations of the process flows and the descriptions thereof may make reference to user windows, webpages, websites, web forms, prompts, etc. Practitioners will appreciate that the illustrated steps described herein may comprise in any number of configurations including the use of windows, webpages, web forms, popup windows, prompts and the like. It should be further appreciated that the multiple steps as illustrated and described may be combined into single webpages and/or windows but have been expanded for the sake of simplicity. In other cases, steps illustrated and described as single process steps may be separated into multiple webpages and/or windows but have been combined for simplicity.

The term “non-transitory” is to be understood to remove only propagating transitory signals per se from the claim scope and does not relinquish rights to all standard computer-readable media that are not only propagating transitory signals per se. Stated another way, the meaning of the term “non-transitory computer-readable medium” and “non-transitory computer-readable storage medium” should be construed to exclude only those types of transitory computer-readable media which were found in In Re Nuijten to fall outside the scope of patentable subject matter under 35 U.S.C. § 101.

In yet another embodiment, the transponder, transponder-reader, and/or transponder-reader system are configured with a biometric security system that may be used for providing biometrics as a secondary form of identification. The biometric security system may include a transponder and a reader communicating with the system. The biometric security system also may include a biometric sensor that detects biometric samples and a device for verifying biometric samples. The biometric security system may be configured with one or more biometric scanners, processors and/or systems. A biometric system may include one or more technologies, or any portion thereof, such as, for example, recognition of a biometric. As used herein, a biometric may include a user's voice, fingerprint, facial, ear, signature, vascular patterns, DNA sampling, hand geometry, sound, olfactory, keystroke/typing, iris, retinal or any other biometric relating to recognition based upon any body part, function, system, attribute and/or other characteristic, or any portion thereof.

Phrases and terms similar to an “entity” may include any individual, consumer, customer, group, business, organization, government entity, transaction account issuer or processor (e.g., credit, charge, etc.), merchant, consortium of merchants, account holder, charitable organization, software, hardware, and/or any other type of entity. The terms “user,” “consumer,” “purchaser,” and/or the plural form of these terms are used interchangeably throughout herein to refer to those persons or entities that are alleged to be authorized to use a transaction account.

Phrases and terms similar to “account”, “account number”, “account code” or “consumer account” as used herein, may include any device, code (e.g., one or more of an authorization/access code, personal identification number (“PIN”), Internet code, other identification code, and/or the like), number, letter, symbol, digital certificate, smart chip, digital signal, analog signal, biometric or other identifier/indicia suitably configured to allow the consumer to access, interact with or communicate with the system. The account number may optionally be located on or associated with a rewards account, charge account, credit account, debit account, prepaid account, telephone card, embossed card, smart card, magnetic stripe card, bar code card, transponder, radio frequency card or an associated account.

The system may include or interface with any of the foregoing accounts, devices, and/or a transponder and reader (e.g. RFID reader) in RF communication with the transponder (which may include a fob), or communications between an initiator and a target enabled by near field communications (NFC). Typical devices may include, for example, a key ring, tag, card, cell phone, wristwatch or any such form capable of being presented for interrogation. Moreover, the system, computing unit or device discussed herein may include a “pervasive computing device,” which may include a traditionally non-computerized device that is embedded with a computing unit. Examples may include watches, Internet enabled kitchen appliances, restaurant tables embedded with RF readers, wallets or purses with imbedded transponders, etc. Furthermore, a device or financial transaction instrument may have electronic and communications functionality enabled, for example, by: a network of electronic circuitry that is printed or otherwise incorporated onto or within the transaction instrument (and typically referred to as a “smart card”); a fob having a transponder and an RFID reader; and/or near field communication (NFC) technologies. For more information regarding NFC, refer to the following specifications all of which are incorporated by reference herein: ISO/IEC 18092/ECMA-340, Near Field Communication Interface and Protocol-1 (NFCIP-1); ISO/IEC 21481/ECMA-352, Near Field Communication Interface and Protocol-2 (NFCIP-2); and EMV 4.2.

The account number may be distributed and stored in any form of plastic, electronic, magnetic, radio frequency, wireless, audio and/or optical device capable of transmitting or downloading data from itself to a second device. A consumer account number may be, for example, a sixteen-digit account number, although each credit provider has its own numbering system, such as the fifteen-digit numbering system used by American Express. Each company's account numbers comply with that company's standardized format such that the company using a fifteen-digit format will generally use three-spaced sets of numbers, as represented by the number “0000 000000 00000”. The first five to seven digits are reserved for processing purposes and identify the issuing bank, account type, etc. In this example, the last (fifteenth) digit is used as a sum check for the fifteen digit number. The intermediary eight-to-eleven digits are used to uniquely identify the consumer. A merchant account number may be, for example, any number or alpha-numeric characters that identify a particular merchant for purposes of account acceptance, account reconciliation, reporting, or the like.

In various embodiments, an account number may identify a consumer. In addition, in various embodiments, a consumer may be identified by a variety of identifiers, including, for example, an email address, a telephone number, a cookie id, a radio frequency identifier (RFID), a biometric, and the like.

Phrases and terms similar to “financial institution” or “transaction account issuer” may include any entity that offers transaction account services. Although often referred to as a “financial institution,” the financial institution may represent any type of bank, lender or other type of account issuing institution, such as credit card companies, card sponsoring companies, or third party issuers under contract with financial institutions. It is further noted that other participants may be involved in some phases of the transaction, such as an intermediary settlement institution.

The terms “payment vehicle,” “financial transaction instrument,” “transaction instrument” and/or the plural form of these terms may be used interchangeably throughout to refer to a financial instrument.

Phrases and terms similar to “merchant,” “supplier” or “seller” may include any entity that receives payment or other consideration. For example, a supplier may request payment for goods sold to a buyer who holds an account with a transaction account issuer.

Phrases and terms similar to a “buyer” may include any entity that receives goods or services in exchange for consideration (e.g. financial payment). For example, a buyer may purchase, lease, rent, barter or otherwise obtain goods from a supplier and pay the supplier using a transaction account.

Phrases and terms similar to “internal data” may include any data a credit issuer possesses or acquires pertaining to a particular consumer. Internal data may be gathered before, during, or after a relationship between the credit issuer and the transaction account holder (e.g., the consumer or buyer). Such data may include consumer demographic data. Consumer demographic data includes any data pertaining to a consumer. Consumer demographic data may include consumer name, address, telephone number, email address, employer and social security number. Consumer transactional data is any data pertaining to the particular transactions in which a consumer engages during any given time period. Consumer transactional data may include, transaction for example, amount, transaction time, transaction vendor/merchant, and transaction vendor/merchant location. Transaction vendor/merchant location may contain a high degree of specificity to a vendor/merchant. For example, transaction vendor/merchant location may include a particular gasoline filing station in a particular postal code located at a particular cross section or address. Also, for example, transaction vendor/merchant location may include a particular web address, such as a Uniform Resource Locator (“URL”), an email address and/or an Internet Protocol (“IP”) address for a vendor/merchant. Transaction vendor/merchant and transaction vendor/merchant location may be associated with a particular consumer and further associated with sets of consumers. Consumer payment data includes any data pertaining to a consumer's history of paying debt obligations. Consumer payment data may include consumer payment dates, payment amounts, balance amount, and credit limit. Internal data may further comprise records of consumer service calls, complaints, requests for credit line increases, questions, and comments. A record of a consumer service call includes, for example, date of call, reason for call, and any transcript or summary of the actual call.

Phrases similar to a “payment processor” may include a company (e.g., a third party) appointed (e.g., by a merchant) to handle transactions. A payment processor may include an issuer, acquirer, authorizer and/or any other system or entity involved in the transaction process. Payment processors may be broken down into two types: front-end and back-end. Front-end payment processors have connections to various transaction accounts and supply authorization and settlement services to the merchant banks' merchants. Back-end payment processors accept settlements from front-end payment processors and, via The Federal Reserve Bank, move money from an issuing bank to the merchant bank. In an operation that will usually take a few seconds, the payment processor will both check the details received by forwarding the details to the respective account's issuing bank or card association for verification, and may carry out a series of anti-fraud measures against the transaction. Additional parameters, including the account's country of issue and its previous payment history, may be used to gauge the probability of the transaction being approved. In response to the payment processor receiving confirmation that the transaction account details have been verified, the information may be relayed back to the merchant, who may complete the payment transaction. In response to the verification being denied, the payment processor relays the information to the merchant, who may decline the transaction. Phrases similar to a “payment gateway” or “gateway” may include an application service provider service that authorizes payments for e-businesses, online retailers, and/or traditional brick and mortar merchants. The gateway may be the equivalent of a physical point of sale terminal located in most retail outlets. A payment gateway may protect transaction account details by encrypting sensitive information, such as transaction account numbers, to ensure that information passes securely between the customer and the merchant and also between merchant and payment processor.

Benefits, other advantages, and solutions to problems have been described herein with regard to specific embodiments. However, the benefits, advantages, solutions to problems, and any elements that may cause any benefit, advantage, or solution to occur or become more pronounced are not to be construed as critical, required, or essential features or elements of the disclosure. The scope of the disclosure is accordingly to be limited by nothing other than the appended claims, in which reference to an element in the singular s not intended to mean “one and only one” unless explicitly so stated, but rather “one or more.” Moreover, where a phrase similar to ‘at least one of A, B, and C’ or ‘at least one of A, B, or C’ is used in the claims or specification, it is intended that the phrase be interpreted to mean that A alone may be present in an embodiment, B alone may be present in an embodiment, C alone may be present in an embodiment, or that any combination of the elements A, B and C may be present in a single embodiment; for example, A and B, A and C, B and C, or A and B and C. Although the disclosure includes a method, it is contemplated that it may be embodied as computer program instructions on a tangible computer-readable carrier, such as a magnetic or optical memory or a magnetic or optical disk. All structural, chemical, and functional equivalents to the elements of the above-described exemplary embodiments that are known to those of ordinary skill in the art are expressly incorporated herein by reference and are intended to be encompassed by the present claims. Moreover, it is not necessary for a device or method to address each and every problem sought to be solved by the present disclosure, for it to be encompassed by the present claims. Furthermore, no element, component, or method step in the present disclosure is intended to be dedicated to the public regardless of whether the element, component, or method step is explicitly recited in the claims. No claim element herein is to be construed under the provisions of 35 U.S.C. 112(f) unless the element is expressly recited using the phrase “means for.” As used herein, the terms “comprises”, “comprising”, or any other variation thereof, are intended to cover a non-exclusive inclusion, such that a process, method, article, or apparatus that comprises a list of elements does not include only those elements but may include other elements not expressly listed or inherent to such process, method, article, or apparatus.

It should be emphasized that the above-described embodiments are merely possible examples of implementations, merely set forth for a clear understanding of the principles of the present disclosure. Many variations and modifications may be made to the above-described embodiment(s) without departing substantially from the spirit and principles of the present disclosure. All such modifications and variations are intended to be included herein within the scope of this disclosure.

Therefore, at least the following is claimed:

1. A method comprising:
receiving, by a wallet application of a user device, a first electronic identification instrument of a user and a first electronic token for the first electronic identification instrument from an identity broker, wherein the first electronic token validates an authenticity of the first electronic identification instrument and the first electronic identification instrument comprises a certified digital image of a first personal identification card of the user; and
presenting, by the wallet application of the user device, the first electronic identification instrument and the first electronic token to a wallet reader of a requestor as part of an online transaction involving the requester.

2. The method of claim 1, wherein payment information is presented with the first electronic identification instrument and the first electronic token to the requestor as part of the online transaction.

3. The method of claim 1, wherein the first personal identification card comprises a driver's license card, a health insurance card, a passport, or a club membership card.

4. The method of claim 1, wherein the certified digital image is embossed with a security feature of the identity broker.

5. The method of claim 1, further comprising storing the first electronic identification instrument and the first electronic token within a secure element of the user device.

6. The method of claim 5, further comprising encrypting the first electronic identification instrument and the first electronic token before storing the first electronic identification instrument and the first electronic token on the secure element of the user device.

7. The method of claim 5, further comprising storing a second electronic identification instrument of the user and a second electronic token in association with the second electronic identification instrument, wherein the second electronic token is different from the first electronic token.

8. A computer-based system comprising:
a computing device comprising a processor and a memory; and machine-readable instructions stored in the memory that, when executed by the processor, cause the computing device to at least:
receive, by a wallet application of the computing device, a first electronic identification instrument of a user and a first electronic token for the first electronic identification instrument from an identity broker, wherein the first electronic token validates an authenticity of the first electronic identification instrument and the first electronic identification instrument comprises a certified digital image of a first personal identification card of the user; and
present, by the wallet application of the computing device, the first electronic identification instrument and the first electronic token to a wallet reader of a requestor as part of an online transaction involving the requester.

9. The computer-based system of claim 8, wherein payment information is presented with the first electronic identification instrument and the first electronic token to the requestor as part of the online transaction.

10. The computer-based system of claim 8, wherein the first personal identification card comprises a driver's license card, a health insurance card, a passport, or a club membership card.

11. The computer-based system of claim 8, wherein the certified digital image is embossed with a security feature of the identity broker.

12. The computer-based system of claim 8, further comprising storing the first electronic identification instrument and the first electronic token within a secure element of the user device.

13. The computer-based system of claim 12, wherein the computing device is further caused to encrypt the first electronic identification instrument and the first electronic token before storing the first electronic identification instrument and the first electronic token on the secure element of the user device.

14. The computer-based system of claim 12, wherein the computing device is further caused to store a second electronic identification instrument of the user and a second electronic token in association with the second electronic identification instrument, wherein the second electronic token is different from the first electronic token.

15. A non-transitory computer-readable medium storing instructions that when executed cause a processor of a computing device to at least:
receive, by a wallet application of the computing device, a first electronic identification instrument of a user and a first electronic token for the first electronic identification instrument from an identity broker, wherein the first electronic token validates an authenticity of the first electronic identification instrument and the first electronic identification instrument comprises a certified digital image of a first personal identification card of the user; and
present, by the wallet application of the computing device, the first electronic identification instrument and the first electronic token to a wallet reader of a requestor as part of an online transaction involving the requester.

16. The non-transitory computer-readable medium of claim 15, wherein payment information is presented with the first electronic identification instrument and the first electronic token to the requestor as part of the online transaction.

17. The non-transitory computer-readable medium of claim 15, wherein the first personal identification card comprises a driver's license card, a health insurance card, a passport, or a club membership card.

18. The non-transitory computer-readable medium of claim 15, wherein the certified digital image is embossed with a security feature of the identity broker.

19. The non-transitory computer-readable medium of claim 15, further comprising storing the first electronic identification instrument and the first electronic token within a secure element of the user device.

20. The computer-based system of claim 19, wherein the computing device is further caused to store a second electronic identification instrument of the user and a second electronic token in association with the second electronic identification instrument, wherein the second electronic token is different from the first electronic token.
